(19) United States
(12) Patent Application Publication
(10) Pub. No.: US 2026/0020710 A1
(43) Pub. Date: Jan. 22, 2026

(54) FOOD HEATING DEVICE AND PORTABLE FOOD HOLDING APPARATUS

(71) Applicant: Innosynth Inc., Englewood, CO (US)

(72) Inventors: JINHONG WU, Shenzhen (CN); Dewen Zeng, Shenzhen (CN)

(21) Appl. No.: 19/270,333

(22) Filed: Jul. 15, 2025

(30) Foreign Application Priority Data
Jul. 16, 2024 (CN) 202421678263.3

(51) Int. Cl. A47J 27/00; A23G 1/04; A47J 41/00; B65D 1/36; B65D 51/24; B65D 51/28; B65D 81/18; H05B 1/02; H05B 3/34

(52) U.S. Cl. CPC A47J 27/004; A23G 1/04; A47J 27/002; A47J 41/0072; B65D 1/36; B65D 51/242; B65D 51/28; B65D 81/18; H05B 1/0252; H05B 3/34; H05B 2203/005

(57) ABSTRACT

a food heating device and portable food holding apparatus are provided, the food holding device includes a base, a food heating device and a receiving container, the base includes a first area and a second area adjacent to the first area, the food heating device is detachably received in the first area of the base and configured for heating a first type of food received in the food heating device to convert the first type of food from a solid state to a molten state, and the receiving container is received in the second area and configured to receive second types of food but not heat the second types of food, wherein the receiving container is rotatably attached to the base and further rotatable with respect to the base and the food heating device.

### RELATED APPLICATIONS

This application claims the benefit of priority to Chinese Patent Application Number 202421678263.3 filed on Jul. 16, 2024, in the China National Intellectual Property Administration. The entire contents of the above-identified application are hereby incorporated by reference.

### TECHNICAL FIELD

The present disclosure relates to the technical field of household apparatus, and in particular, to a food heating device, especially for a portable food holding apparatus which can contain foods and heat the foods.

### BACKGROUND

Food holding apparatus is a necessity tool in daily life for holding foods. However, in some specific requirements, such as an apparatus for holding food (such as a fruit bowl, a nut bowl, a candy box, etc.) which is usually placed on a dining table or a tea table and is used to hold food which can be directly taken by a user, or a food holding device for holding food which needs to be heated when eating. In order to enhance a taste of the food, it is necessary to heat the food before eating. However, the food holding apparatus commonly used for the above requirements does not have a food heating function to meet users' requirements.

For example, chocolate fruit is a specialty food that is coated with chocolate on a surface of fruit and is popular in Europe and America. It is widely provided at gathering occasions, such as weddings, ceremonies. A process of making chocolate fruits is very simple. First, heat chocolate to melt the chocolate, then put fruits into the melted chocolate. Each surface of the fruits is covered with a layer of chocolate, and the chocolate fruits are formed when the chocolate covered on each surface of the fruits cools to a solid state. However, in general, the chocolate is heated separately by a heating device, and a compote is only used for holding the fruits which are directly taken form the compote, which may cause inconvenience for a user. Therefore, designing a structure or method to meet facilitate the user may be desired.

### BRIEF DESCRIPTION OF DRAWINGS

In order to illustrate the technical solution in embodiments of the present invention more clearly, the following briefly introduces accompanying drawings used in the description of the embodiments. Obviously, the accompanying drawings in the following description are only some embodiments of the present invention. Those of ordinary skill in the art can obtain other accompanying drawings from these accompanying drawings without any creative efforts.

FIG. 1 is a schematic block diagram of a food heating device according to a first embodiment of the present disclosure, the food heating device includes an inner housing, an outer housing, a heating structure, a control device, a power supply device and a temperature sensor.

FIG. 2 is an exploded view of the food heating device shown in FIG. 1.

FIG. 3 is a cross-sectional view of the food heating device shown in FIG. 1.

FIG. 4 is a diagram showing a structure of the heating structure according to an alternative embodiment of the present disclosure.

FIG. 5 is a diagram showing a main heating electrical circuit of the food heating device shown in FIG. 1.

FIG. 6 is a diagram showing a secondary heating electrical circuit of the food heating device shown in FIG. 1.

FIG. 7 is a diagram showing a display circuit of the food heating device shown in FIG. 1.

FIG. 8 is a diagram showing a control circuit of the food heating device shown in FIG. 1.

FIG. 9 is a diagram showing a USB interface circuit of the food heating device shown in FIG. 1.

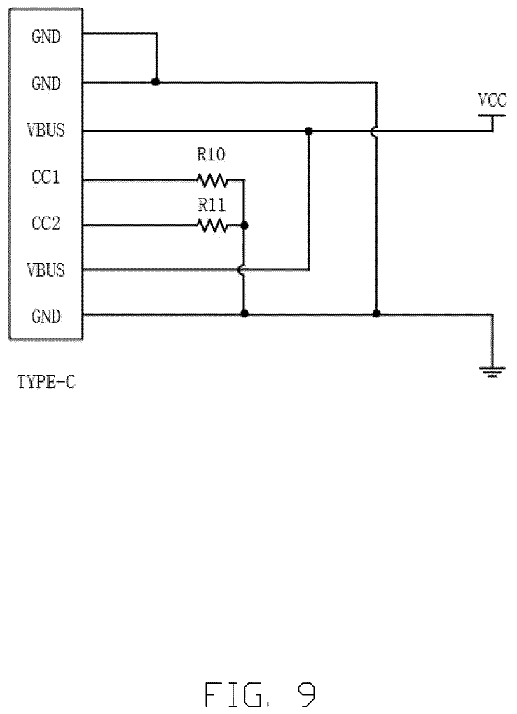

FIG. 10 is a diagram showing a charging circuit of the food heating device shown in FIG. 1.

FIG. 11 is a diagram showing a buck circuit of the food heating device shown in FIG. 1.

FIG. 12 is a perspective view of an application embodiment of a portable food holding apparatus with both the outer housing of the food heating device shown in FIG. 1, and a tray cover be removed.

FIG. 13 is a cross-sectional view of the portable food holding apparatus shown in FIG. 12, showing a complete structure of the portable food holding apparatus.

FIG. 14 is an exploded view of the portable food holding apparatus shown in FIG. 13.

FIG. 15 is an exploded view of the portable food holding apparatus shown in FIG. 13, viewed from another view direction.

FIG. 16 is a variant embodiment of the application embodiment of a portable food holding apparatus shown in FIG. 12 and FIG. 13.

FIG. 17 is a schematic view showing a holding state of a first type of food and a second type of food of the portable food holding apparatus.

FIG. 18 is a diagram showing a usage state of the first type of food and the second type of food of the portable food holding apparatus shown in FIG. 17.

FIG. 19 is a perspective view of a food heating device according to a second embodiment.

FIG. 20 is an exploded view of the food heating device shown in FIG. 19, the food heating device includes a first base, an inner liner and a second cover.

FIG. 21 is an exploded view of the food heating device shown in FIG. 19, viewed from another view direction.

FIG. 22 is a sectional view of the food heating apparatus shown in FIG. 19, viewed along an A-A direction.

FIG. 23 is an exploded view of the inner liner of the food heating device shown in FIG. 20.

FIG. 24 is an exploded view of the first base of the food heating device shown in FIG. 20.

FIG. 25 is a schematic view of the second cover in an open state shown in FIG. 20.

### DETAILED DESCRIPTION

Reference will now be made in detail to representative embodiments illustrated in the accompanying drawings. It should be understood that the following descriptions are not intended to limit the embodiments to one preferred implementation. To the contrary, the described embodiments are intended to cover alternatives, modifications, and equivalents as can be included within the spirit and scope of the disclosure and as defined by the appended claims.

### First Embodiment

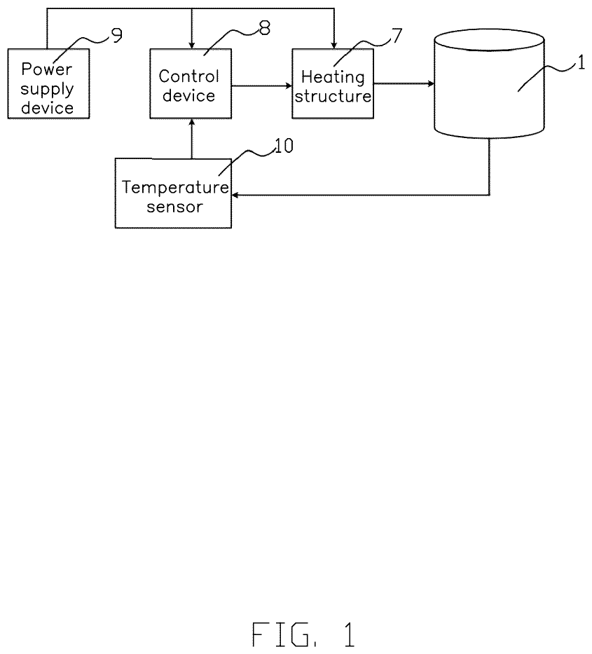

Refer to FIGS. 1 to 3, a food heating device 100 for heating a food, such as chocolate, is provided in this present disclose. The food heating device 100 includes a shell 10a having a double layered wall structure, a heating structure 7, a control device 8, a power supply device 9 and a thermal insulation plate 13. The shell 10a defines a container for holding a first type of food, and the double layered wall structure includes an inner housing 1 defining the container, and an outer housing 3 surrounding the inner housing 1. The outer housing 3 surrounds around an outer surface of the inner housing 1. The heating structure 7 and the thermal insulation plate 13 are arranged between the inner housing 1 and the outer housing 3, the inner housing 1 is configured to contain a first type of food, and the heating structure 7 is configured for heating the inner housing 1 so as to heat the first type of food in the inner housing 1.

The inner housing 1 includes a bottom wall 1a and a side wall 1b extending from the bottom wall 1a. The bottom wall 1a and the side wall 1b cooperatively define an housing, with an opening, of the container. A shape of the housing includes but is not limited to a circular cylinder, a circular truncated cone, a prism, and a prismatic frustum and the like. A receiving space is defined in the housing of the inner housing 1 and configured to receive the first type of food. In some embodiments of the present disclosure, the first type of food may be chocolate, and the inner housing 1 is made of a heat-conductive material, including but not limited to metal iron, metal copper, metal aluminum and their alloy. When heat is generated by the heating structure 7, and the heat is transferred to the chocolate through the inner housing 1, causing the chocolate to change from a solid state to a fluid state or keeping the chocolate in a fluid state.

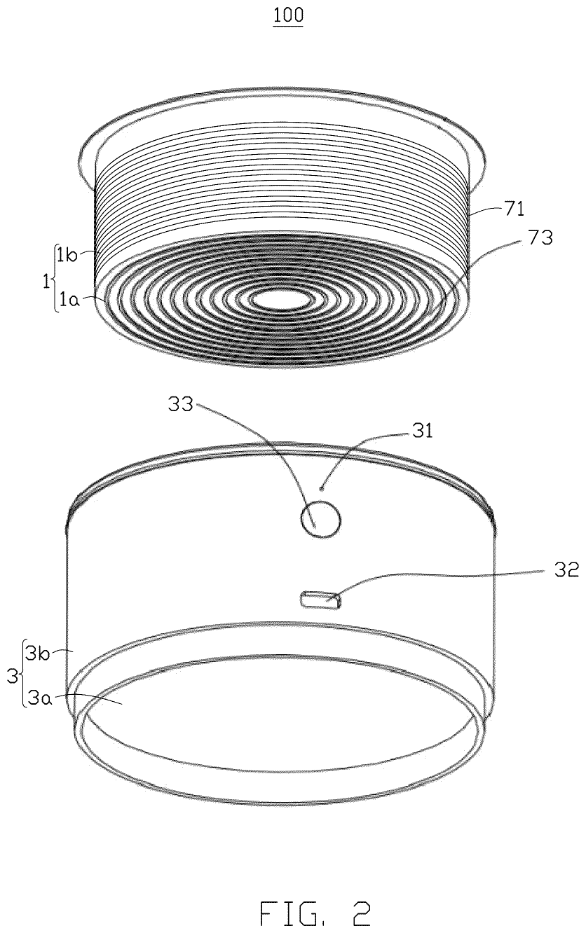

Refer to FIG. 2, the outer housing 3 includes a bottom wall 3a and a side wall 3b, the bottom wall 3a and the side wall 3b cooperates to form a cylinder with a top opening. A shape of the cylinder corresponds to the shape of the inner housing 1. The outer housing 3 is connected to the inner housing 1 to form the double layered wall structure, and a certain distance is provided between the outer surface of the inner housing 1 and the inner surface of the outer housing 3, thereby defining a cavity 11. The outer housing 3 is made of heat insulation materials, such as bamboo, wood, ceramic, and plastic.

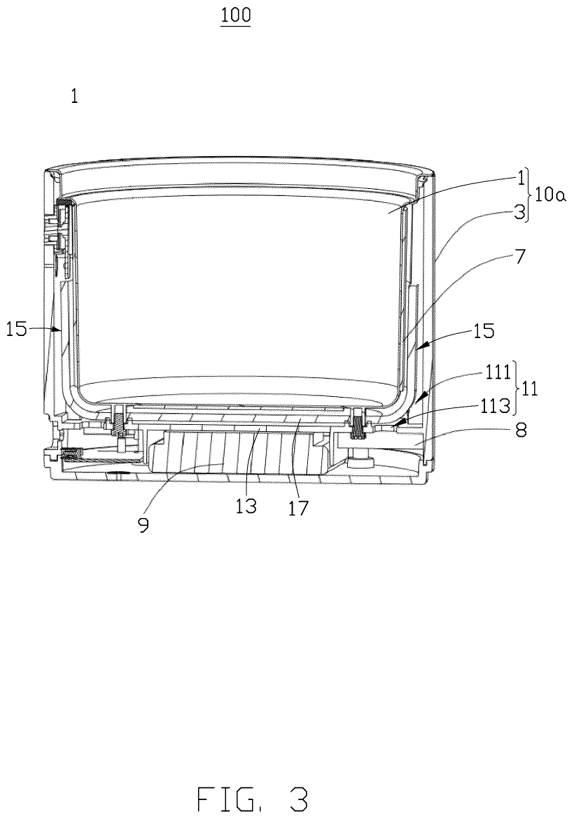

Referring to FIG. 3, the heating structure 7 features flexibility and is capable of being bent to conform to the outer surface of the side wall 1b of the inner housing 1. Due to the presence of a first region 111, which is defined between the side wall 1b of the inner housing 1 and the side wall 3b of the outer housing 3, of the cavity 11, the heating structure 7 in direct contact with the inner housing 1 does not contact with the outer housing 3, the first region 111 of the cavity 11 has a function of insulating heat to prevent the outer housing 3 from overheating. Moreover, the cavity 11 further includes a second region 113 located between the bottom wall 1a of the inner housing 1 and the bottom wall 3a of the outer housing 3, and the heating structure 7 is further located in the second region 113 and is preferably attached to the out surface of the bottom wall 1a of the inner housing 1. Due to the presence of the second region 113, the heating structure 7 in direct contact with the bottom wall 3a does not contact with the bottom wall 3b, the second region 113 of the cavity 11 has a function of insulating heat for insulating heat transferring to the control device 8 and the power supply device 9. In can be understood that in the second region 113, a vertical distance between the inner housing 1 and the outer housing 3 is not a tiny close clearance fit, but is more than 1 mm, for example, 10 mm, 50 mm and 100 mm.

In some embodiments of the present disclosure, the thermal insulation plate 13 is provided inside the outer housing 3 and divides the side wall 3b into an upper portion and a lower portion. The inner housing 1 is disposed in the upper portion and on/above the thermal insulation plate 13. A receiving cavity is defined in the thermal insulation plate 13, the side wall 3b of the outer housing 3, and the bottom wall 3a of the outer housing 3, and the control device 8 and the power supply device 9 are both received in the receiving cavity. The thermal insulation plate 13 is made of a material which can inhibit heat transfer.

In some embodiments of the present disclosure, the cavity 11 further includes heat preservation materials for reducing the heat dissipation efficiency of the inner housing 1. The heat preservation materials can be for example a first heat preservation component 15 located at a first location between a portion of the heating structure 7 and a second heat preservation component 17 positioned at a second location between another portion of the heating structure 7 and the outer housing 3. The first location is between the inner side wall 3b of the outer housing 3 and the outer side wall 1b of the inner housing 1, and the second location is between the inner bottom wall 3a of the outer housing 3 and the outer bottom wall 1a of the inner housing 1. The first and second heat preservation components 15 and 17 are configured to reduce the heat dissipation efficiency of the inner housing 1. In this embodiment, the heat preservation components 15 and 17 are directly attached to a side of the heating structure 7 away from the inner housing 1. The materials for manufacturing the first and second heat preservation components 15 and 17 include, but are not limited to, glass fiber insulation wool, foam board, and rock wool board. In other embodiments, a mounting container is installed at a bottom of the outer housing 3. The mounting container recesses to form a mounting space with an opening, and the bottom of the outer housing 3 covers the opening of the mounting space. The power supply device 9 is disposed in the mounting space, and the mounting space has a function of insulating heat to prevent the power supply device 9 from receiving heat from the outer housing 3. In some embodiments of the present disclosure, the heat preservation materials only include the first heat preservation component 15 but omits the second heat preservation component 17. In an alternatively embodiment of the present disclosure, the heat preservation materials only includes the second heat preservation component 17 but omits the first heat preservation component 15.

In some other embodiments of the present disclosure, the cavity 11 may be formed between the inner housing 1 and the outer housing 3, with the thermal insulation plate 13 and the heat preservation materials omitted. In an alternatively embodiment of the present disclosure, the cavity 11 formed between the inner housing 1 and the outer housing 3 may contain either the thermal insulation plate 13 or the heat preservation materials.

The heating structure 7 is directly attached to the inner housing 1 and configured to heat the inner housing 1. The heating structure 7 may be arranged on an outer surface of the inner housing 1, so that the first type of food that is held in the inner housing 1 is heated. Thus, the chocolate of the inner housing 1 melts from the solid state to the fluid state. In this embodiment, the heating structure 7 includes one or more heating wires which have a high electrical resistivity and a low temperature coefficient, it can convert electrical energy into thermal energy when powered on. Especially, the heating structure 7 includes a first heating wire 71 and a second heating wire 73. The first heating wire 71 is wrapped multiple times around a side wall 1b of the inner housing 1, and the second heating wire 73 is wrapped multiple times on a bottom wall 1a of the inner housing 1. The first heating wire 71 and the second heating wire 73 can be separately controlled. When the heating structure 7 is electrically connected to the power supply device 9, at least one of the first heating wire 71 and the second heating wire 73 converts the electrical energies into the heat energies for raising the temperature inside the inner housing 1. In some other embodiments, while the inner housing 1 is made of metal iron or iron alloy, the heating structure 7 may be an electromagnetic inductor, which uses electromagnetic inductions to generate eddy currents in the inner housing 1. The eddy currents cause high-speed irregular movements of charge carriers at the bottom of the inner housing 1, and the collisions and frictions between charge carriers and atoms generate heat energies, thereby raising the temperature inside the inner housing 1.

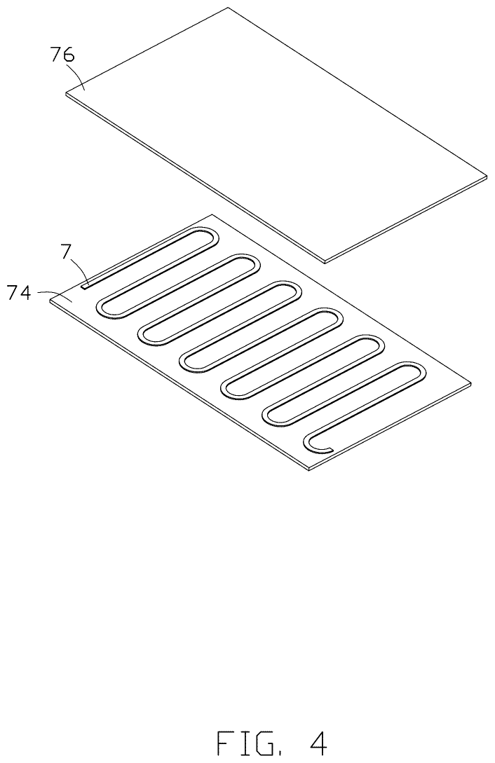

Referring to FIG. 4, in some other embodiments, the heating structure 7 further includes a first insulating film 74 and a second insulating film 76, and one of the first heating wire 71 and the second heating wire 73 is disposed between the first insulating film 74 and the second insulating film 76. The first heating wire 71 and the second heating wire 73 have a S-shape, and one of the first heating wire 71 and the second heating wire 73 connects to the first insulating film 74 and the second insulating film 76 via an adhesive. When the heating structure 7 is attached to the outer surface of the inner housing 1, the first insulating film 74 and the second insulating film 76 can not only isolate the heat of the heating wires but also prevent the heating wires from folding into a mass, so that the inner housing 1 can be uniformly heated. Both the first insulating film 74 and the second insulating film 76 are made of deformable materials, such as plastic films and silicone films. The deformable materials can directly attach to the outer surface of the inner housing 1 with various shapes. In this embodiment, the first heating wire 71, the second heating wire 73, the first insulating film 74 and the second insulating film 76 are all made of deformable materials, such that the heating structure 7 can directly deform and surround on the side wall 1b of the inner housing 1 and cover on the bottom wall 1a of the inner housing 1.

In some other embodiments, the heating structure 7 further includes a third heating element, which overlap on a surface of the first heating wire 71. The control device 8 is electrically connected to the heating structure 7 and is configured to control a heating efficiency of the heating structure 7. Generally, when a heating efficiency of an object is equal to its heat dissipation efficiency, the object is considered to be in a thermal equilibrium state. Therefore, the control device 8 increases the heating efficiency of the heating structure 7, making the heating efficiency of the inner housing 1 higher than its heat dissipation efficiency, thereby raising the temperature of the inner housing 1.

The control device 8 is electrically connected to the heating structure 7 and configured to control the heating efficiency of the heating structure 7. Generally, when the heating efficiency of an object is the same as a heat dissipation efficiency of the object, the object is considered to be in a thermal equilibrium. Thereby, the control device 8 increases the heating efficiency of the heating structure 7 to make the heating efficiency of the inner housing 1 higher than the heat dissipation efficiency of the inner housing 1, thereby raising the temperature inside the inner housing 1. The control device 8 decreases the heating efficiency of the heating structure 7 to make the heating efficiency of the inner housing 1 lower than the heat dissipation efficiency of the inner housing 1, thereby controlling the temperature inside the inner housing 1. The control device 8 controls the heating efficiency of the heating structure 7 to maintain the temperature inside the inner housing 1 below a first temperature and above a second temperature. The first temperature is higher than a melting point of the chocolate. and the heating device 3 heats and melts the first type of food, such as chocolate, within the temperature range from the melting point of the first type of food to the first temperature. In this embodiment, because the chocolate begins to melt at a temperature of 36° C. and the sugar in the chocolate begins to scorch at a temperature of 60° C., the first temperature is preferably set to 60° C. and the second temperature is preferably set to 36° C. Thus, the temperature of the chocolate after being heated by the heating structure 7 is maintained between 36° C. and 60° C.

The power supply device 9 is electrically connected to the heating structure 7 and the control device 8 for providing power. The power supply device 9 may include a battery which acts as the power source. The power supply device 9 may further include a power adapter for receiving the electric supply and applying to the heating structure 7 and the battery.

Refer to FIG. 1, the food heating device 100 further includes a temperature sensor 10 for measuring the temperature inside the inner housing 1. The temperature sensor 10 is disposed adjacent to the inner housing 1, especially, on the outer surface of the inner housing 1. The temperature sensor 10 is electrically connected to the control device 8 and transmits a temperature signal to the control device 8 in real time. When the temperature inside the inner housing 1 has dropped to the second preset temperature, the control device 8 increases the heating efficiency of the heating structure 7 to raise the temperature inside the inner housing 1. On the contrary, when the temperature inside the inner housing 1 has risen to the first preset temperature, the control device 8 decreases the heating efficiency of the heating structure 7 to lower the temperature inside the inner housing 1. The temperature sensor 10 may be, but not limited to, a thermistor, a thermocouple, an infrared temperature sensor.

In some other embodiments, the heating structure 7 includes a first heating mode and an insulation mode. When the heating structure 7 is in the first heating mode, the heating structure 7 releases a large amount of heat, causing the temperature inside the inner housing 1 to rise rapidly. When the heating structure 7 is in the insulation mode, the heating structure 7 releases a moderate amount of heat, and the heating efficiency of the inner housing 1 is slightly lower than the heat dissipation efficiency, causing the temperature inside the inner housing 1 to drop slowly.

In an alternative embodiment, the heating structure 7 includes at least one heating wire. The control device 8 regulates the heating efficiency of the heating structure 7 changing the proportion of working time per unit time of the at least one heating wire. When the proportion of working time per unit time of the heating wire is increased, the heating efficiency of the heating structure 7 improves; when the proportion of working time per unit time of the heating wire is reduced, the heating efficiency decreases.

In an alternative embodiment, the heating structure 7 includes at least two heating wires. The control device 8 regulates the heating efficiency by changing the number of heating wires in the operating state. When a number of operating heating wires is increased, the heating efficiency of the heating structure 7 improves; when the number is decreased, the heating efficiency decreases.

In another alternative embodiment, the heating structure 7 includes three heating wires, one of the three heating wires is arranged at the bottom of the inner housing 1 and two of the three heating wires cooperate to arrange on the side wall of the inner housing 1. When the heating structure 7 is in the first heating mode, three heating wires are operational, releasing a large amount of heat. When the heating structure 7 is in the insulation mode, only a heating wire arranged at the bottom of the inner housing 1 operates, causing the temperature inside the inner housing 1 to drop slowly.

In other embodiments, the heating structure 7 also includes a standby mode. When the heating structure 7 is in standby mode, no heating wires are operational, and the temperature inside the inner housing 1 drops rapidly.

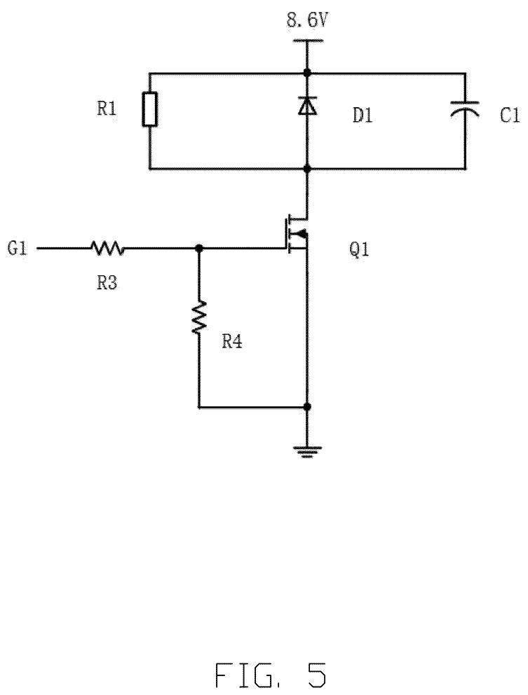

In some embodiments, the heating structure 7 includes a main heating circuit and a secondary heating circuit, and the main heating circuit corresponding to a heating mode and a heating preservation mode, the secondary heating circuit corresponding to a standby mode. Refer to FIG. 5, the main heating circuit includes a first heating wire R1, a first diode D1, and a first transistor Q1. When the food heating device 100 is in the heating mode, a first control signal G1 which is transmitted from the control device 8 is at a high level, the first transistor Q1 is turned on, the electrical power is grounding after the first heating wire R1 and the first transistor Q1, and then the first heating wire R1 is in an operation state to heat the inner housing 1. When the food heating device 100 is in the heating preservation mode, the first control signal G1 is also at the high level, so that the first heating wire R1 is in an operation state to heat the inner housing 1. When the food heating device 100 is in the standby mode, the first control signal G1 is at a low level, the first transistor Q1 is turned off, and the first diode D1 prevents the electrical power from flowing back, the first heating wire R1 cannot form a current loop, so that the first heating wire R1 is not in the operation state, the inner housing 1 is thus not heated by the first heating wire R1.

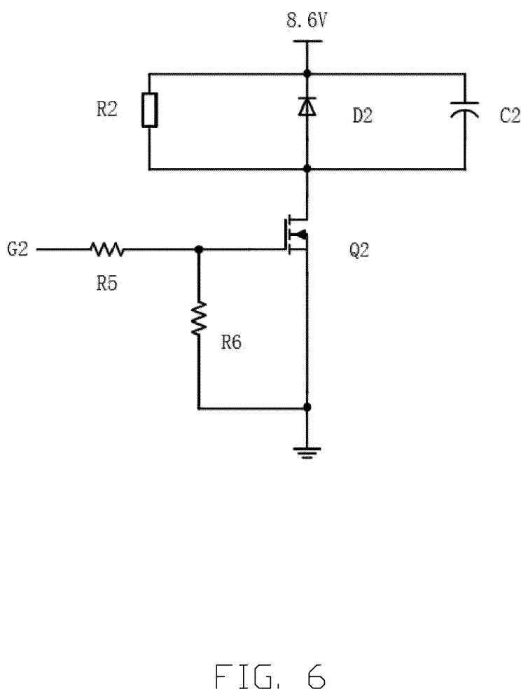

Refer FIG. 6, the secondary heating circuit includes a second heating wire R2, a second diode D2, and a second transistor Q2. When the food heating device 100 is in the heating mode, a second control signal G2 which is transmitted from the control device 8 is at a high level, the second transistor Q2 is turned on, and the second heating wire R2 is in an operation state to heat the inner housing 1. When the food heating device 100 is in anyone of the heat preservation mode and the standby mode, the second control signal G2 is at a low level, the second transistor Q2 is turned off, and the second heating wire R2 is not in the operating state, so that the inner housing 1 is not heated.

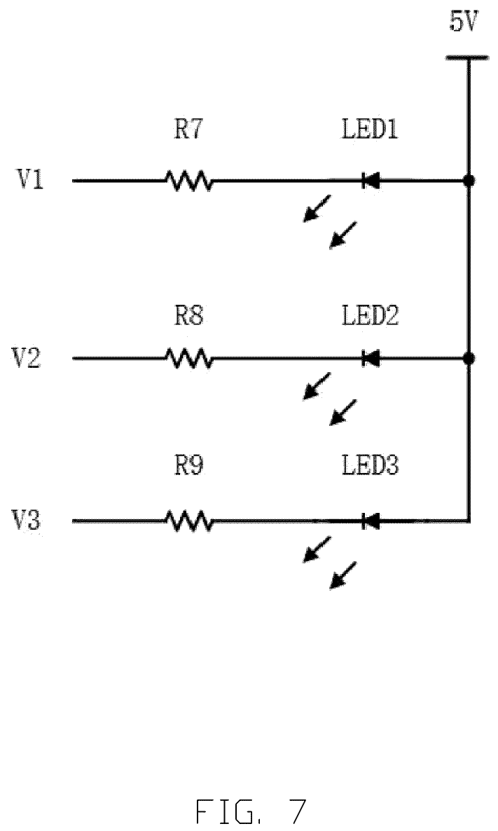

In some other embodiments, the food heating device further includes a display device having a display circuit. Referring to FIG. 7, the display circuit includes three light-emitting diodes LED 1, LED 2, and LED 3. Three cathodes of the LED 1-3 are connected to a first terminal V1, a second terminal V2 and a third terminal V3 respectively, three anodes of the LED1-3 are connected to a power supply terminal, applied with a fixed voltage (e.g. a 5V voltage). Input voltages applied to the first, second and third terminals V1-V3 are controlled by the control device 8. In a normal state, the input voltages are set to switch of the three light-emitting diodes LED 1, LED 2, and LED 3 (e.g. 3V voltage, 2V voltage, and 1.5V voltage, respectively). Thereby, the LED 1, LED 2, and LED 3 are turned off in the normal state. When the food heating device 100 is in the heating mode, the input voltage of the first terminal V1 is controlled to be decreased, so as to switch on the light-emitting diode LED 1. When the food heating device 100 is in the heat preservation mode, the input voltage of the second terminal V2 is controlled to be decreased, so as to switch on the light-emitting diode LED2. When the food heating device 100 is in the standby mode, the input voltage of the third terminal voltage V3 is controlled to be decreased, so as to switch on the light-emitting diode LED3. In this embodiment, the light-emitting diodes LED 1, LED 2, and LED 3 emit red, green, and white light after being conducted, respectively. The three modes, including the heating mode, the heat preservation mode and the standby mode, are switchable. When the operating modes of the food heating device 100 are switched among these three modes, the display device correspondingly displays the corresponding light to alert users.

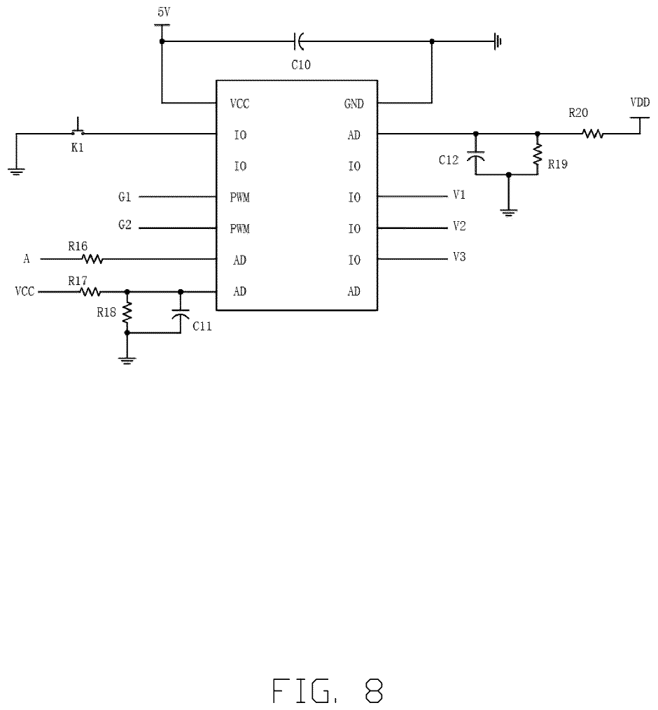

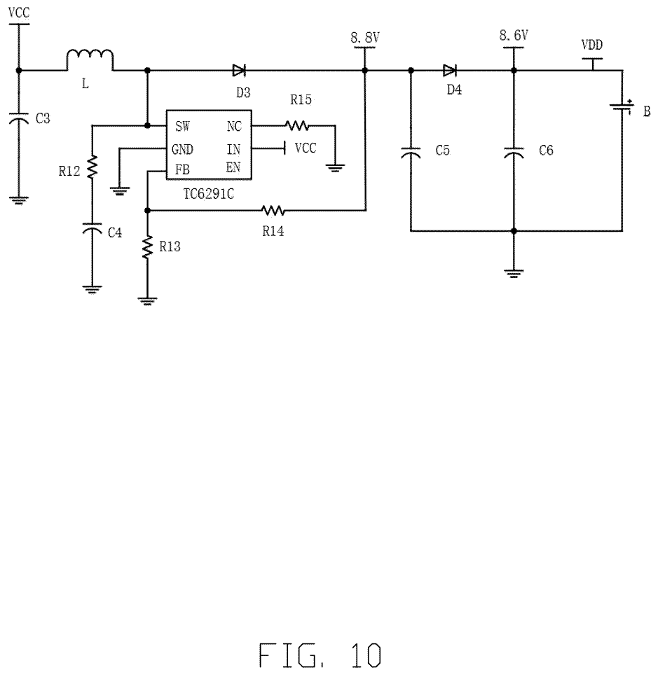

Refer to FIG. 8, the control device 8 includes a control circuit configured for outputting the first control signal G1 to control the main heating circuit and the second control signal G2 to control the secondary heating circuit. The control circuit is also configured to output the first voltage V1, the second voltage V2, and the third voltage V3 to control the light-emitting diodes LED1, LED2, and LED3, respectively. The control device 8 is capable of automatically controlling the temperature inside the inner housing 1. In another embodiments, the control device 8 can control the temperature inside the inner housing 1 by signals input by users. Specifically, refer to FIG. 10, an electrical signal is received when a button K1 is pressed, and the control circuit receives the electrical signal. When the mechanical button K1 is pressed for the first time, the control circuit receive a first electrical signal, outputs the first control signal G1 at the high level and the second control signal G2 at the high level, so as to control the heating structure 7 to switch to the heating mode, and decreases the first voltage V1 to turn on the light-emitting diode LED1, simultaneously. When the button K1 is pressed for the second time, the control circuit receives a second electrical signal and outputs the first control signal G1 at the high level and the second control signal G2 at the low level, so as to control the heating structure 7 to switch to the heat preservation mode, resets the first voltage V1 to turn off the light-emitting diode LED1, decreases the second voltage V2 to turn on the light-emitting diode LED2, simultaneously. When the button K1 is pressed for the third time, the control circuit receives a third electrical signal and outputs the first control signal G1 at the low level and the second control signal G2 at the low level to control the heating device 7 to switch to the standby mode, resets the second voltage V2 to turn off the light-emitting diode LED2, decreases the third voltage V3 to turn on the light-emitting diode LED3, simultaneously.

In one embodiment, the power supply device 9 may be a battery device, and the battery device includes a USB interface circuit, a charging circuit, and a buck circuit. Refer to FIG. 5 and FIG. 6, the USB interface circuit is configured to provide a voltage VCC, a boost circuit is formed at a left side of the charging circuit for charging a battery B which is located at a right side. The voltage VCC is raised after transmitting the boost circuit, so that a voltage output from the boost circuit is raised to 8.8 V. Assuming that the battery has been fully depleted at this point (the voltage VDD is 0 V), a fourth diode D4 conducts, so that the boost circuit charges the battery B. When the battery B is fully charged, a voltage difference between an anode and a cathode of the fourth diode D4 is less than a conduction voltage, the fourth diode D4 turns off, and the boost circuit stops charging the battery B.

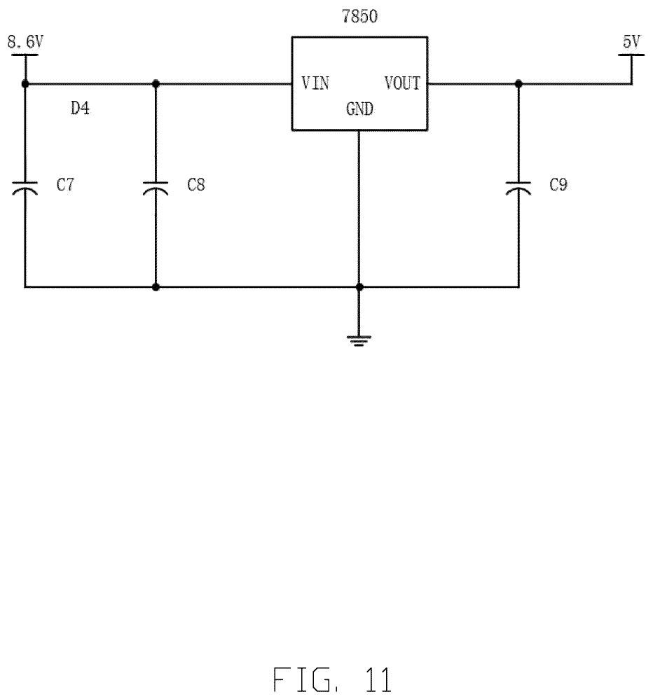

Refer to FIG. 11, the buck circuit is configured to reduce the battery voltage to 5V, which is the supply voltage required by the display circuit and the control circuit. The above mentioned 8.6V serves as the supply voltage of the main heating circuit and the secondary heating circuit. In some other embodiments, the charging circuit can also be designed to directly charge the battery B using the voltage VCC, and the main heating circuit and the secondary heating circuit are powered by an un-boosted voltage VDD. In an alternatively embodiment, the charging circuit can be designed to directly charge the battery B using the voltage VCC, and the voltage VDD is boosted to power the main heating circuit and the secondary heating circuit.

In some other embodiments, the control circuit also receives the USB interface voltage VCC and the battery voltage VDD to control a power supply mode of the battery device 9. When the battery B is charging, the main heating circuit and the secondary heating circuit are powered by the voltage VDD, that is to say, the control circuit allows charging the battery B while supplying power to the heating structure 7. In another embodiment, when the control circuit detects that the battery B is charging, the control circuit switches the supply voltage of the main heating circuit and the secondary heating circuit to the voltage VCC. In some other embodiments, when the control circuit detects that the battery B is charging, the control circuit switches the main heating circuit and the secondary heating circuit to a non-operation state, and then the heating structure 7 will stop heating. In an alternatively embodiment, when the control circuit detects that the battery B is charging and the main heating circuit or the secondary heating circuit is in the operation state, the control circuit prevents the charging circuit from charging the battery B.

### First Application Embodiment

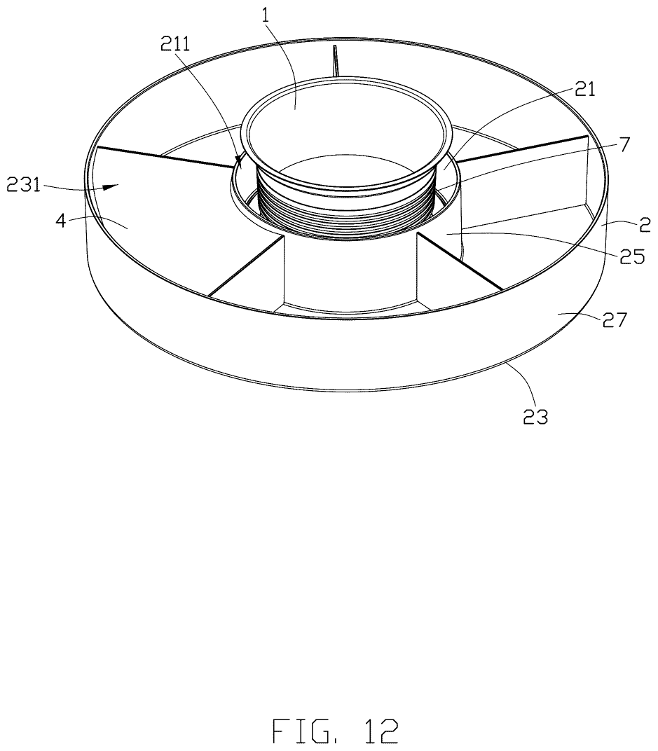

Refer to FIGS. 12 to 15, the portable food holding apparatus 1000 includes the food heating device 100, a base and a cover 6. The food heating device 100 is covered by the cover 6. The base includes a supporting plate 5 and an accommodating container 2 rotatably connected to the supporting plate 5. The food heating device 100 is detachably arranged on the supporting plate 5 and supported by the supporting plate 5.

The food heating device 100 is configured to heat the first type of food, causing the first type of food to convert to a fluid state or remain in a fluid state, while the accommodating container 2 is configured for containing second types of food. In this embodiment, the second types of food include different kinds of fruits, such as strawberries, apples, nuts, and candies.

The accommodating container 2 includes a tray body 21 and a tray cover 29. The tray body 21 is rotatably connected to the supporting plate 5, and a plurality of receiving containers 4 are detachably received on the tray body 21. The tray cover 29 is configured to cover the plurality of receiving containers 4.

The tray body 21 is disposed on the supporting plate 5. It may be an annular box, which includes an annular-shaped bottom wall 23, an inner wall 25 and an outer wall 27, the inner wall 25 and the outer wall 27 perpendicularly extend from opposite sides of the bottom wall 23. The outer wall 27 cooperates with the bottom wall 23 and the inner wall 25 to define a second receiving space 231 in the accommodating container 2. The inner wall 25 defines a first receiving space 211 for receiving the outer housing 3. A plurality of spacing plates radially extend from the inner wall 25 to the outer wall 27, so as to form a plurality of second receiving spaces 231 in the accommodating container 2. In this embodiment, the first receiving space 211 is slightly larger than the outer housing 3 and configured to receive the outer housing 3. The second receiving spaces 231 are configured to receive the second types of food, the second types of food may different from the first type of food which is held in the food heating device 100.

In some alternative embodiments of the present disclosure, the plurality of receiving containers 4 have shapes matching with shapes of the second receiving spaces 231, and are detachably received in the second receiving spaces 231. The plurality of receiving containers 4 are configured to receive the different kinds of fruits. Therefore, the fruits can be placed in the plurality of receiving containers 4 instead of being directly placed in the second receiving space 231. Each receiving container 4 includes a bottom wall and a side wall. The bottom wall of the receiving container 4 is a circular sector ring shape, and the side wall of the receiving container 4 is connected to the bottom wall to form a sector ring cavity with a top opening. Therefore, in use, the foods can be held in the plurality of receiving containers 4. After use, the plurality of receiving containers 4 can selectively detach from the accommodating container 2 for washing.

In this embodiment, the accommodating container 2 and the plurality of receiving containers 4 are made of heat insulation materials, such as bamboo, wood, ceramic, and plastic.

In some other embodiments, the tray cover 29 is provided with a handle, the handle is configured to lift up the tray cover 29.

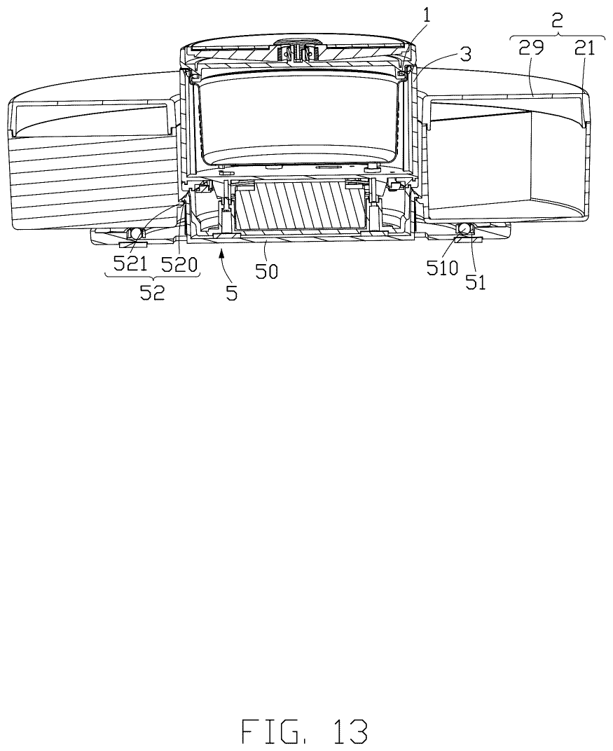

Refer to FIG. 13, the outer housing 3 of the food heating device 100 is disposed in the first receiving space 211 and on the supporting plate 5. An outer side wall of the outer housing 3 abuts against the inner wall 25, so that the outer housing 3 can be taken out of the first receiving space 211. The outer side wall of the outer housing 3 is provided with a display light 31, a USB interface 32, and a button 33, which cooperates with the display circuit, the USB interface circuit, and the control circuit to achieve corresponding functions, respectively.

Refer to FIG. 13, the supporting plate 5 is configured for supporting the accommodating container 2 and the outer housing 3. In this embodiment, the supporting plate 5 includes a plate 50, a sliding structure 51 arranged on the plate 50.

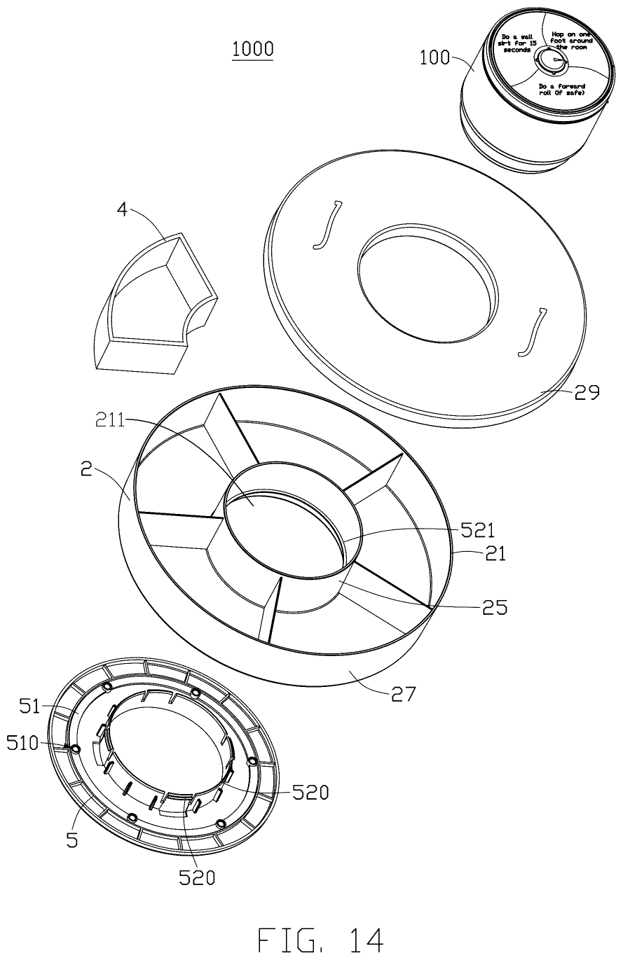

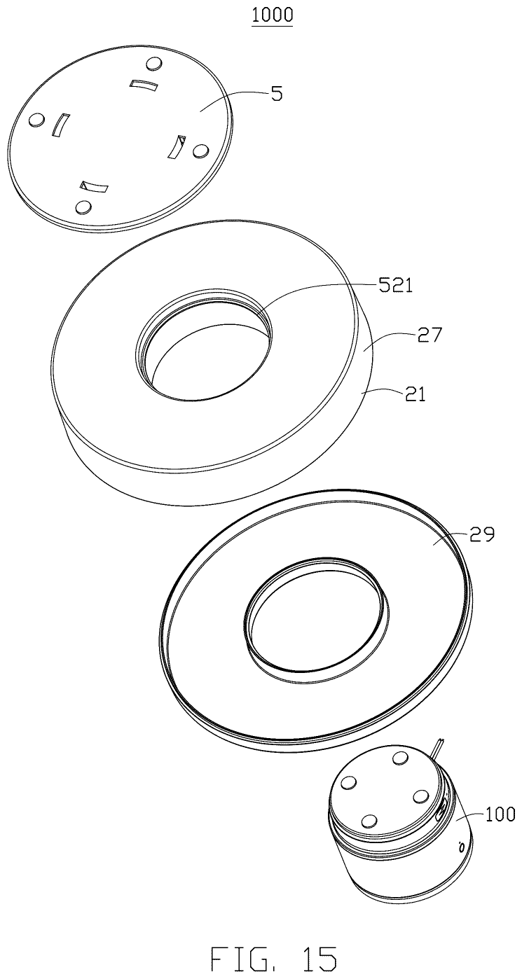

Refer to FIG. 14 and FIG. 15, an outer bottom wall 23 of the accommodating container 2 includes an imaginary second annular track overlapping a first annular track of the plate 50. A plurality of holes are defined in the first annular track. A plurality of beads 510 are partially received in the holes and are capable of rolling in the holes. Atop portion of each bead 510 is protruded out of each hole and engageable with the second annular track. When the accommodating container 2 is forced to move relative to the supporting plate 5 by a user, the plurality of beads 510 roll on the second annular track. The plurality of beads 510 are configured to reduce the friction between the supporting plate 5 and the accommodating container 2. Therefore, this allows the user to easily pick up the second types of food in the accommodating container 2 or the plurality of receiving containers 4.

A connecting structure 52 is further formed on the supporting plate 5 and the accommodating container 2 for connecting the supporting plate 5 and the accommodating container 2. The connecting structure 52 includes a first connecting portion 520 and a second connecting portion 521 engaging with the first connecting portion 520. The first connecting portion 520 is at least one hook extending from the plate 50 of the supporting plate 5 and located at an inner side of the first annular track. The second connecting portion 521 is a flange protruding from an inner wall 25 of the accommodating container 2 and towards a center of the accommodating container 2. The first connecting portion 520 hooks on the flange 521 so as to assemble the supporting plate 5 and the accommodating container 2 and limit a movement the accommodating container 2 relative to the supporting plate 5 in an arrangement direction, such as up-down direction. The first connecting portion 520 is slidable on the flange 521 when it engages with the flange 521. Specifically, the first connecting portion 520 has an annular mounting wall extending from the plate 50 and insertable into the first receiving space 211 of the accommodating container 2. At least one pair of slits defined in the mounting wall, each pair of slits defines one first elastic portion therebetween. The first elastic portion has a hook which extends laterally from a free end of the first elastic portion. A first opening, surrounded by the flange, is defined in the center of the accommodating container 2. The outer housing 3 is located within a second opening surrounded by the mounting wall with the mounting wall around an outer circumference of the outer housing 3. A third connecting portion is formed to detachably fasten the outer housing 3 on the supporting plate 5 and prevents the outer housing 3 from sliding in the second opening. The second opening is in air communication with the first opening, and overlaps with the first opening when the accommodating container 2 is attached to the supporting plate 5. A size of a virtual circle defined by the hooks is larger than the size of the first opening. In assembly, the annular mounting wall of the supporting plate 5 is forced to insert into the first opening of the accommodating container 2 by an external force. The first elastic portion will deform inward for reducing the size of the virtual circle. When the size of the virtual circle is smaller than that of the first opening, the first connecting portion 520 is wholly received into the second opening, the hook flange is pressed to abut the flange by the first elastic portion, thereby preventing the hook from moving in a left-right direction and disengaging with the flange in an insertion direction of the base, e.g. the up-down direction. Atop portion of the inner housing 1 protrudes from the accommodating container 2, so that the melted first type of food placed in the inner housing 1 is prone to overflow into the accommodating container 2 and covers the second types of food in the accommodating container 2. In this embodiment, the accommodating container 2 is rotatable around the insertion direction by the plurality of beads 51 rolling with respect to the supporting plate 5 and the outer housing 3.

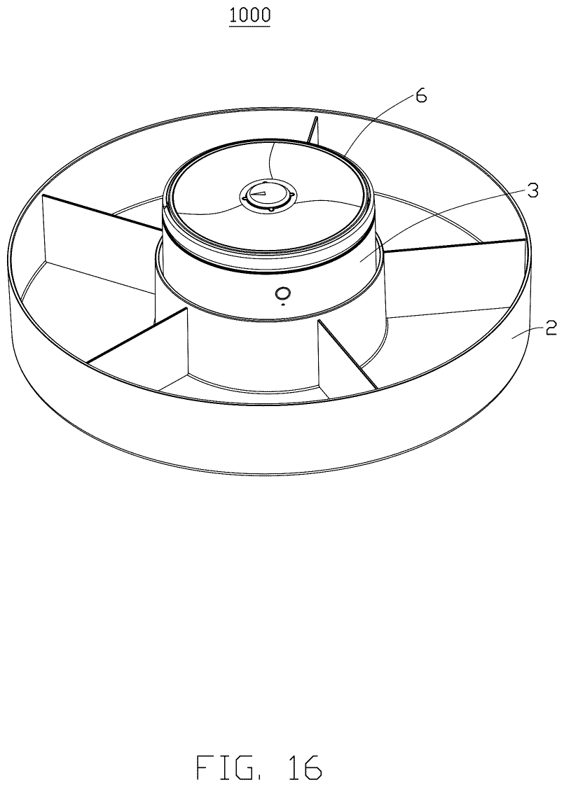

Referring to FIG. 16, the cover 6 is covered on a top end of the inner housing 1 for shielding ducts. A game turntable is provided in the cover 6 to provide an entertainment way for the user. The game turntable includes a rolling bearing, on which a game card is installed. and the game card is capable of rotating with the rolling bearing. The game turntable further includes a main body, the main body has a hollow area to define a recess area, the game card, a first plate and a metal plate are both received in the main body, and an end of the rolling bearing is protruded from the recess area. The first plate with a first magnetic structure is provided above the game card, and the metal plate with a second magnetic structure is provided below the game card, the first magnetic structure magnetically attracts the second magnetic structure, so that the game card is fixed between the first plate and the metal plate. The game card is marked with various rewards and punishments, each occupying a small sector area. A fixed pointer is provided above the first plate. When the rolling bearing is rotated, the game card rotates simultaneously. When the game card stops, the fixed pointer points to the reward or punishment in the corresponding sector area.

In some embodiments, the game turntable may not be provided with a rolling bearing, and the game card can be rotated by directly flicking the metal plate or the first plate. In other embodiments, the game card in the game turntable is fixed, and the fixed pointer above the first plate is rotated to point to the rewards or punishments on the game card.

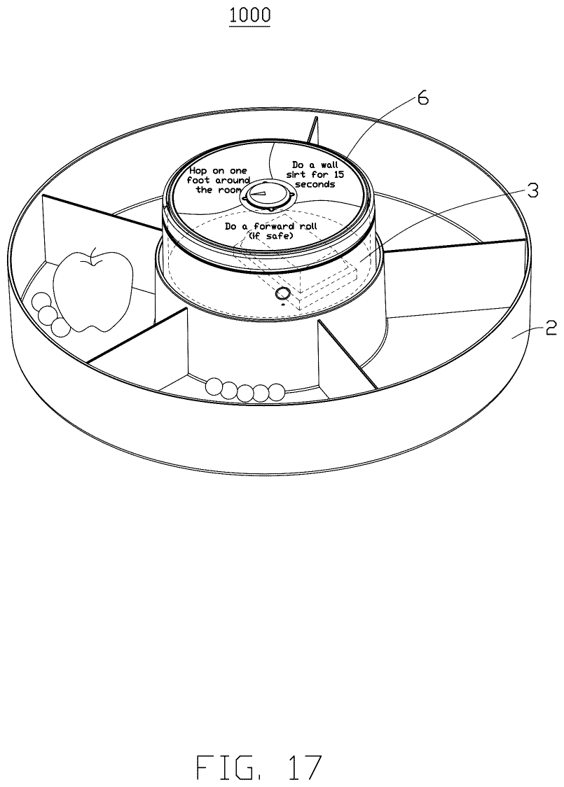

Refer to FIG. 17, at least a piece of chocolate is received in the inner housing 1 of the outer housing 3, the chocolate is not heated by the heating structure 7, that is to say, the piece of chocolate is in the solid state, a fruit is received in the accommodating container 2.

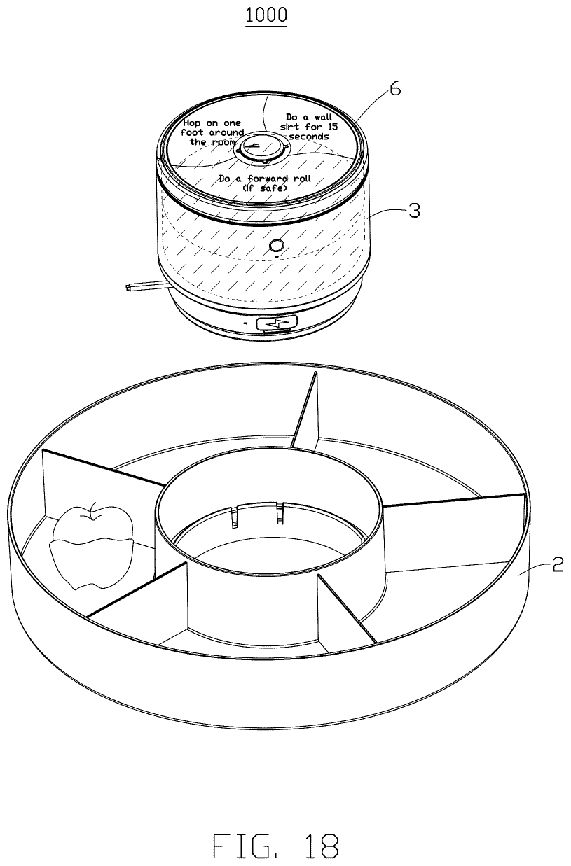

Refer to FIG. 18, the chocolate is received in the inner housing 1 of the food heating device 100 and is heated by the heating structure 7 to converted into a fluid state from the solid state, and a surface of the fruit received in the accommodating container 2 is cover with a melted chocolate.

### Second Embodiment

Reference numerals same as those in Embodiment 1 continue to be used for same elements in this embodiment. A difference between this embodiment and Embodiment 1 lies in that a structure of the food heating device 100a.

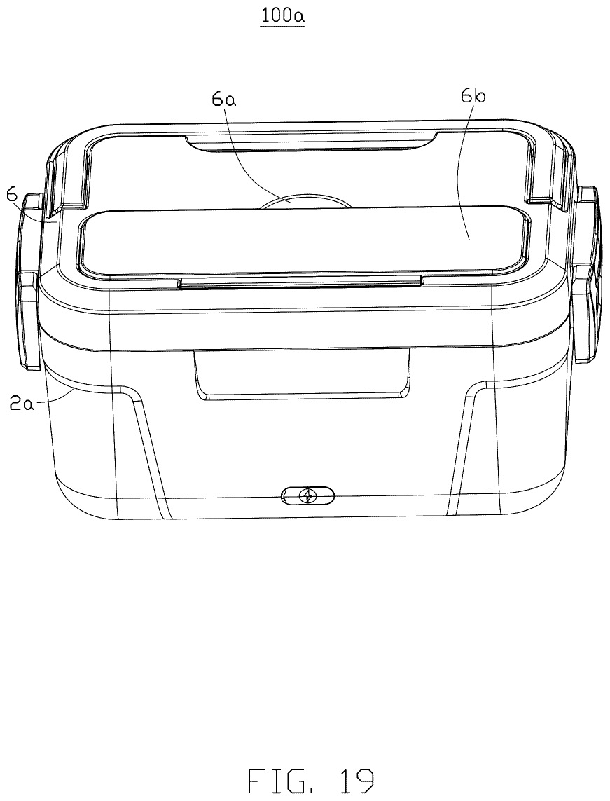

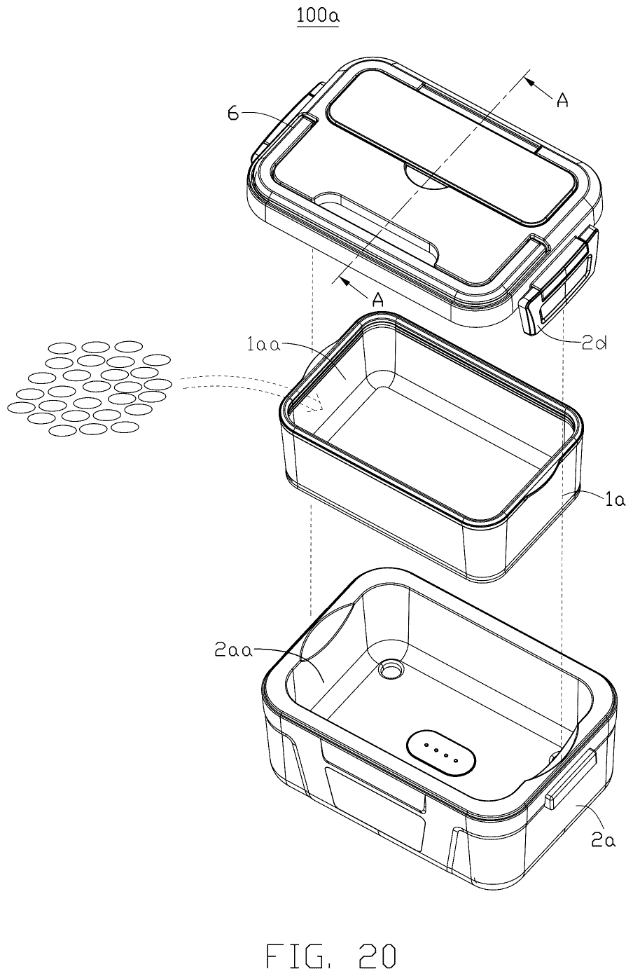

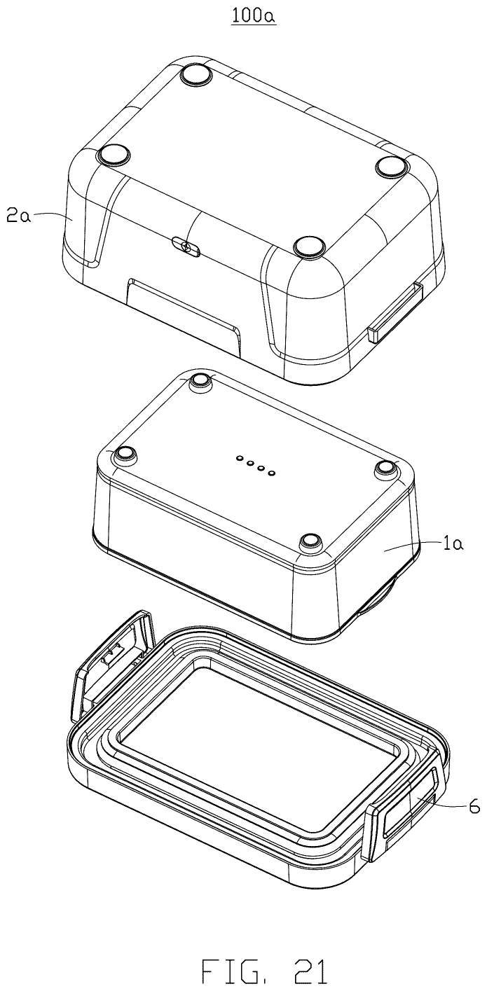

Referring to FIGS. 19 to 21, the food heating device 100a includes a first base 2a, an inner liner 1a and a second cover 6. The first base 2a is recessed to form a fourth accommodating space 2aa, which is configured to receive the inner liner 1a such that the inner liner 1a is at least partially received within the fourth accommodating space 2aa. The inner liner 1a is detachably mounted on the first base 2a. The inner liner 1a is recessed to form a fifth accommodating space 1aa for holding different kinds of food such as bread, rice, and noodles. The second cover 6 is configured to cover and seal the fifth accommodating space 1aa of the inner liner 1a, thereby maintaining an airtightness of the fifth accommodating space 1aa.

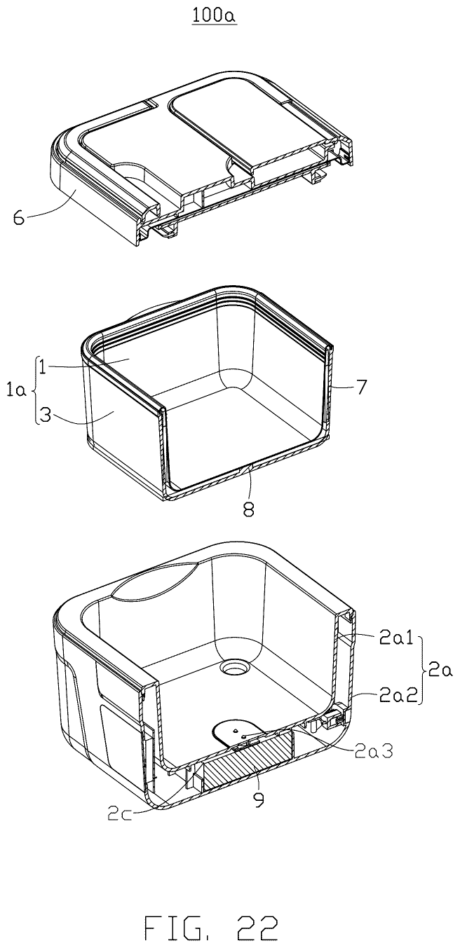

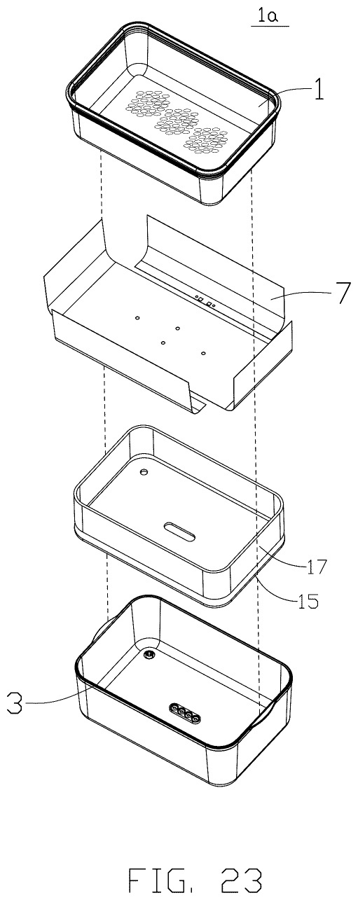

Referring to FIG. 22 and FIG. 23, the inner liner 1a includes an inner housing 1, an outer housing 3, a heating structure 7, a control device 8, and thermal insulation members 15 and 17. The inner housing 1 is received in the outer housing 3, and the heating structure 7, the control device 8, and the thermal insulation members 15 and 17 are all disposed between the inner housing 1 and the outer housing 3.

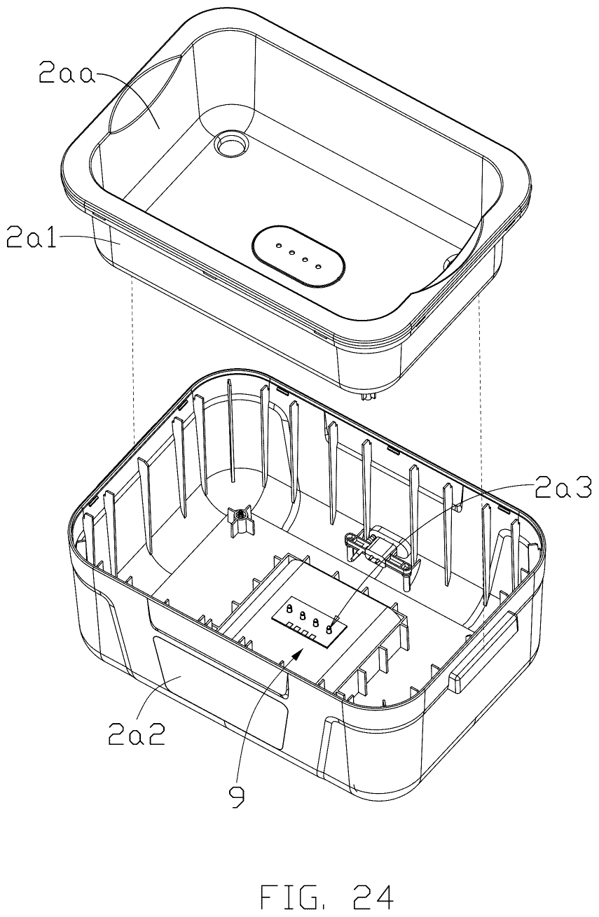

Referring to FIG. 24, the first base 2a includes a third container 2a1 and a receiving container 2a2. The fourth accommodating space 2aa is defined in the third container 2a1, and the third container 2a1 is received in the receiving container 2a2. A power supply device 9 is disposed between the third container 2a1 and the receiving container 2a2. Additionally, the base 2a further includes a plurality of elastic pins 2a3. One end of each elastic pin 2a3 is disposed on an inner wall of the third container 2a1, and another end of each elastic pin 2a3 passes through the third container 2a1 and connects to the power supply device 9. A connection pin (not shown), which is electrically connected to the heating structure 7, is provided on an outer wall of the outer housing 3 and is configured to electrically connected to the plurality of elastic pins 2a3.

In some embodiments, a second air insulation cavity 2c is defined between the power supply device 9 and the third container 2a1 so as to achieve complete isolation between the power supply device 9 and the heating structure 7, thereby enhancing safety of the power supply device 9.

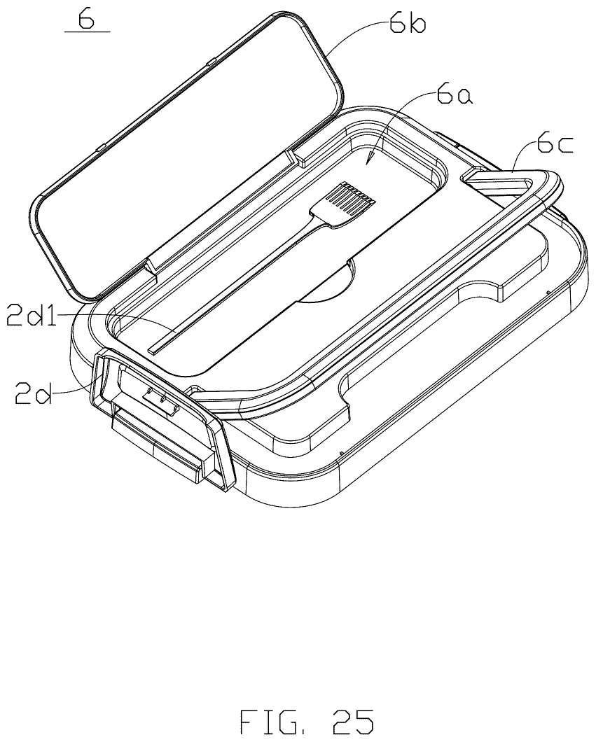

Referring to FIG. 25, a tray cover 6 is detachably connected to the base 2a via a locking structure 2d. When the tray cover 6 is in a locked state, the locking structure 2d covers the inner housing 1 to maintain the airtightness of the inner housing 1. When the tray cover 6 is in a detached state, the inner housing 1 is in air communication with the external environment.

A storage slot 6a and a removable cover 6b for covering the storage slot 6a are provided on the top of the tray cover 6. The storage slot 6a is used for storing a fork 2d1.

A handle 6c is provided on a top of the tray cover 6 to facilitate a user to carry the food heating device 100a.

What we are claimed is:

1. A food holding apparatus comprising:
a base comprising a first area and a second area located adjacent to the first area;
a food heating device detachably received in the first area of the base; the food heating device comprising:
a shell having a double layered wall structure, and defining a container configured for holding a first type of food in a solid state and in a molten state; the double layered wall structure comprising an inner housing forming the container, an outer housing surrounding the inner housing, and a cavity located between the inner housing and the outer housing, the cavity configured for providing heat insulation between the outer housing and the inner housing;
a deformable heating material received in the cavity and directly attached to an outer surface of the inner housing; and
at least one receiving container, received in the second area and configured for receiving a second type of food,
wherein the at least one receiving container is detachably supported by the base and the base is rotatable with respect to the food heating device.

2. The food holding apparatus according to claim 1, wherein
the base comprises a supporting plate and an accommodating container rotatably engaged with the supporting plate, the supporting plate is supported by a supporting surface, and the at least one receiving container is detachably received in the accommodating container and is further rotatable with the accommodating container with respect to the supporting plate.

3. The food holding apparatus according to claim 2, wherein
the accommodating container comprises an annular-shaped bottom wall, an inner wall and an outer wall, the inner wall and the outer wall perpendicularly extend from opposite sides of the bottom wall, and the outer wall cooperates with the bottom wall and the inner wall to define a second receiving space in the accommodating container, the at least one receiving container is received in the second receiving space, the inner wall defines a hollow space, which includes a first opening adjacent to the supporting plate and a top opening facing the first opening, to receive the food heating device; and a portion of the supporting plate is insertable into the base via the first opening.

4. The food holding apparatus according to claim 3, wherein
at least one spacing plate radially extends from the inner wall to the outer wall, the second receiving space is divided, by the at least one spacing plate, into at least two small second receiving spaces in the accommodating container, each of the at least one receiving container is received in a corresponding small second receiving space of the at least two small second receiving spaces.

5. The food holding apparatus according to claim 3, wherein
the supporting plate comprises a plate supported by the supporting surface, and a first connecting portion protruded from a side of the plate towards the first opening of the accommodating container, the plate is engaged with the accommodating container through the first connecting portion.

6. The food holding apparatus according to claim 5, further comprising a limiting structure configured to limit a rotating direction of the accommodating container, and comprising a hook and a flange, wherein the first connecting portion comprises an annular mounting wall, the hook protrudes out of the annular mounting wall of the first connecting portion, and the flange protrudes, corresponding to the hook, from the inner wall toward the first opening;
a top surface of the flange abuts against a bottom surface of the hook, when the accommodating container rotates relative to the base, the flange is limited to rotate around the annular mounting wall and maintained abutting against the bottom surface of the hook.

7. The food holding apparatus according to claim 6, wherein
a second opening is defined in the annular mounting wall and configured for receiving the food heating device,
at least one pair of slits are defined in the annular mounting wall, each pair of the at least one pair of slits defines one first elastic portion therebetween,
when the annular mounting wall is inserted into the first opening of the accommodating container by an external force, the first elastic portion deforms inward, and the second opening is further configured for proving a deform space to accommodate the first elastic portion.

8. The food holding apparatus according to claim 2, wherein the plate comprises an annular track towards the accommodating container, and a plurality of holes are defined in the annular track and configured to receive a plurality of beads;
a portion of each bead of the plurality of beads is movably received in a corresponding hole of the plurality of beads, and a remaining portion of each of the plurality of bead is protruded out of the corresponding hole and engageable with the accommodating container.

9. The food holding apparatus according to claim 1, further comprising a cover, wherein the cover comprises a main body, a fixed pointer and a game card, the main body is configured to cover a top opening of the food heating device, and a recess area is defined in the main body, the game card is rotatably received in the recess area, and the fixed pointer is fixed in an outer surface of the main body.

10. The food holding apparatus according to claim 1, wherein
the cavity comprises a first region defined between a side wall of the inner housing and a side wall of the outer housing, and a second region defined between a bottom wall of the inner housing and a bottom wall of the outer housing, the first region is in air communication with the second region.

11. The food holding apparatus according to claim 10, further comprising a heat preservation material located in at least one of the first region and the second region, the heat preservation material is configure to reduce a heat dissipation efficiency of the inner housing.

12. The food holding apparatus according to claim 1, wherein the deformable heating material includes a first heating wire and a second heating wire, the first heating wire surrounds a periphery of a side wall of the inner housing, and the second heating wire covers an entire bottom wall of the inner housing;
the first heating wire and the second heating wire are electrically connectable to an external power source via the outer housing.

13. The food holding apparatus according to claim 1, wherein the first type of food comprises a chocolate, and the second types of food comprise at least one of fruits, nuts, or confectioneries.

14. A food heating device applied to a food holding device, comprising:
a shell having a double layered wall structure, and defining a container configured for holding a first type of food; the double layered wall structure comprising an inner housing forming the container, an outer housing surrounding the inner housing, and a cavity located between the inner housing and the outer housing, the cavity configured for providing heat insulation between the outer housing and the inner housing;
a deformable heating material received in the cavity and configured for heating the first type of food in the inner housing, the deformable heating material comprising a first heating material and a second heating material, wherein the first heating material surrounds on an outer surface of the first side wall of the inner housing, and the second heating material directly attaches to an outer surface of the first bottom wall of the inner housing; and
at least one heat preservation material, configured to reduce a heat dissipation efficiency of the inner housing, and being positioned in one of a first position and a second position of the cavity, wherein the first position is located between the first heating material and the second side wall of the outer housing, and the second position is located between the second heating material and the second bottom wall of the outer housing;
a power source, electrically connected to the deformable heating material and configured for supplying power energy to the deformable heating material.

15. The food heating device according to claim 14, wherein the cavity comprising a first region which is defined between the first side wall of the inner housing and the second side wall of the outer housing and a second region which is defined between the first bottom wall of the inner housing and the second bottom wall of the outer housing, the first region is in air communication with the second region.

16. The food heating device according to claim 14, wherein the outer housing is made of a heat insulation material.

17. The food heating device according to claim 14, wherein the battery is accommodated on a side of the outer housing away from the inner housing and is disposed opposite to the cavity.

18. The food heating device according to claim 17, further comprising a mounting container, wherein a mounting space with a top opening is defined in the mounting container, and a bottom wall of the outer housing covers the top opening of the mounting container, the battery is disposed in the mounting space, the mounting space has a function of insulating heat to prevent the battery from receiving heat of the deformable heating material.

19. The food heating device according to claim 14, further comprising a first base, wherein a fourth accommodating space is defined in the first base, and the outer housing is detachably received in the fourth accommodating space.

20. The food heating device according to claim 14, wherein the deformable heating material comprises a heating wire and two insulating films, the two insulating films are attached to opposite sides of the heating wire, one of the two insulating films directly attaches to an outer surface of the inner housing and improve heating efficiency of the heating wire.
